(19) United States
(12) Patent Application Publication
(10) Pub. No.: US 2012/0164282 A1
(43) Pub. Date: Jun. 28, 2012

(54) Light Glaze for Popcorn

(75) Inventors: Gary V. Peterson, Stockton, CA (US); Kathy Wendel, Stockton, CA (US)

(73) Assignee: DIAMOND FOODS, INC., Stockton, CA (US)

(21) Appl. No.: 13/379,833

(22) PCT Filed: Jul. 1, 2010
(86) PCT No.: PCT/US10/40807

§ 371 Date: Mar. 13, 2012

Related U.S. Application Data
(60) Provisional application No. 61/222,898, filed on Jul. 2, 2009.

(51) Int. Cl. A23L 1/18; B65D 81/34

(52) U.S. Cl. 426/107

(57) ABSTRACT

Disclosed are microwave popcorn articles comprising any conventional microwave popcorn bag, and a food charge disposed therein comprising kernel popcorn, fat, salt and sufficient amounts of a heat tolerant glaze forming carbohydrate ingredient such as isomalt to provide the finished popped popcorn with sweet glaze coating. Methods of preparing such microwave popcorn articles are disclosed wherein the isomalt in particulate form in a separate step and preferably after the kernel popcorn and fat have been added to the bag.

This application claims the benefit of U.S. provisional application 61/222,898 filed on Jul. 2, 2009, which is hereby incorporated herein in its entirety for all purposes.

### FIELD OF THE INVENTION

The present invention relates to packaged food products and to their methods of preparation. In particular, the present invention relates to microwave popcorn product articles for preparing sweetened popcorn and to methods for filling such articles.

### BACKGROUND OF THE INVENTION

Popcorn is a highly popular snack food item. In the past, the at-home preparation of popcorn by the consumer involved adding kernel popcorn plus a cooking oil to a covered pot and heating until the popcorn kernels popped to make popcorn. As used herein, “kernel popcorn” refers to unpopped popcorn. The noun “popcorn” or synonymously “popped popcorn” refers herein to popped kernel popcorn. The adjective “popcorn” can refer to either. Once prepared, common, relatively coarse, table salt is a frequently added flavoring or condiment. The resultant salted popped popcorn is a familiar snack food.

More recently, microwave popcorn products have become extremely popular. At present, in the U.S., over 70 different brands of microwave popcorn products are available. In general, the more popular microwave popcorn products comprise an expandable paper bag containing a charge of kernel popcorn, and optionally fat and/or salt. The microwave popcorn article is adapted to be heated in a microwave oven for three to five minutes to produce the popped popcorn. More recently, improved microwave popcorn articles have been fabricated employing a metallized susceptor which facilitates the heating of the kernel popcorn-fat charge and which, in turn, leads desirably to increases in popcorn volume and decreases in unpopped kernels. Microwave popcorn articles of this type are described in detail in, for example, U.S. Pat. No. 4,450,180 (issued May 22, 1984 to J. D. Watkins and incorporated herein by reference).

The fat component is generally flavored with artificial butter flavor although microwave popcorn with real butter products are known and commercially available (see U.S. Pat. No. 5,919,505 “Shelf-Stable Butter Containing Microwave Popcorn Article and Method of Preparation” issued Jul. 6, 1999 to Monsalve et al.).

Sweet popcorn products or “kettle corn” popcorn are well known. Among these, caramel popcorn has long been a popular food item. Such products generally comprise a sweet coating, typically from sucrose and/or small amounts of brown sugar and/or sugar based syrups such as molasses or black strap sugar syrup to provide a caramel flavor and that can also contain butter and/or other fat(s). Bulk amounts of popcorn are prepared (sometimes admixed with nuts) and the sugar-based coating is applied thereto by manufacturers to make the caramel popcorn. Quantities are provided in suitable consumer packaging such as bags whether or not in cartons or other suitable containers, e.g., plastic tubs. Various amounts of salt are added to provide a merely sweet to a sweet-and-salty flavor. With lesser amounts of coating, the coated popcorn can be free flowing. With more coating, agglomerated pieces or even popcorn balls are made.

Microwave products for preparing a sweetened puffed products are known (see for example U.S. Pat. No. 4,409,250 to Van Hulle et al.). However, sweet microwave puffed products comprising sugars can exhibit scorching or even runaway heating due to the high microwave absorption by sugars and salt and the low browning or burning temperatures of sugar. (For a description of such problems, see, for example U.S. Pat. No. 5,443,858 “Composition For Sweetening Microwave Popcorn; Method And Product” issued Aug. 22, 1995 to Jensen, et al.). In extreme case, the microwave bag can actually ignite due to the burning sugars. Sugar scorching problems are aggravated by salt making provision of “sweet and salty” products (i.e., products having a more pronounced salt flavor due to higher levels of salt) especially difficult. The excessive heat can also scorch the popcorn.

One approach for providing a microwave popcorn product having a sweet or cheese coating that does not scorch or burn during microwave popcorn popping is to separately package the coating from the microwave popcorn for post popping addition thereto (see for example, U.S. Pat. No. 4,904,488 “Uniformly-Colored, Flavored, Microwaveable Popcorn” issued Feb. 27, 1990 to LaBaw et al.).

Another approach is described in U.S. Pat. No. 5,443,858 “Composition for Sweetening Microwave Popcorn; Method and Product (issued Aug. 22, 1995 to Jensen et al.). The '858 teaches a microwave popcorn article including a food charge formulated to include in addition to popcorn ingredients for forming a coating to the popped popcorn. The coating feature ingredients are selected to include a low moisture coarser granulation sugars in combination with selection of a low melting point oil and salt and moisture level control to provide a microwave sweet popcorn product.

Another technique for providing a sweet microwave popcorn product is to employ in substitution for low temperature burning temperature sugars a sweetening agent that exhibits greater tolerance to higher temperatures such as acetylsulfame K and/or Sucralose. Sucralose was not approved for use in microwave popcorn products in the United States until August 1999 when sucralose was approved for use for all food categories. Soon thereafter, several microwave popcorn manufacturers began marketing sweet or “kettle corn” microwave popcorn products (see for example, published US patent application U.S. 2002/0127306 “Sweet and Salty Microwave Popcorn Compositions; Arrangements and Methods”). Such products generally employ low levels of the intensely sweet sucralose typically dispersed or diluted in small amounts of a heat tolerant powdered carrier or diluent such as a maltodextrin and avoid inclusion of temperature sensitive sugar ingredients. While useful, the sweetened microwave popcorn prepared from such microwave popcorn products lack the quantity of coating or glaze typical of bagged popped caramel popcorn and thus the eating qualities of such heavily coated sweet products. Also, sucralose is a high value, high cost ingredient.

Thus, there is a continuing need for new and useful microwave popcorn products that can be used to provide sweet popped popcorn having a substantial coating level that minimizes undesirable scorching and fire hazards. There is also a need for such products that can be formulated employing less expensive ingredients. There is also a need for consumer food products that are low in or free of “artificial” or high potency sweeteners.

Surprisingly, the above objectives can be realized, and new and improved shelf stable consumer retail products can be provided for the microwave preparation of a sweet popcorn product containing substantial amounts of a sweet coating with minimal scorching problems. The present improvement provides microwave popcorn products comprising a slurry with a combination of ingredients, including isomalt, that exhibits improved non-scorch performance in a “light” coating with good taste characteristics.

Bagged caramel popcorn having a coating comprising isomalt and sucralose is useful for health reasons. The product does not contain sugar and is beneficial especially for the consumer having interest in products for diabetics.

Surprisingly, unlike other caramel coating ingredients, isomalt has now been found suitable for use for inclusion into microwave products for the at-home microwave preparation of popcorn having substantial amounts of a sweet coating. More surprisingly, such products exhibit minimal scorching during preparation using conventional consumer home microwave oven heating. Even more surprisingly, such microwave products can be formulated to include conventional or even elevated levels of salt to provide even “sweet and salty” coated popcorn.

The present description further provides methods of fabrication microwave popcorn products containing isomalt. The methods can comprise separate addition of isomalt in particulate form.

One generalized composition of popcorn article including isomalt and related method was described in commonly owned U.S. patent application Ser. 10/408,425 filed Apr. 7, 2003, the contents of which is incorporated herein by reference. Still preferable over the known popcorn articles would be an improved light glazing for popcorn exhibiting desirable characteristics, such as those relating to non-scorching and flavor.

### BRIEF SUMMARY

In its article aspect, the present microwave popcorn articles essentially comprise a microwave popcorn bag and food charge dispersed therein. The food charge comprises kernel popcorn, ground isomalt, butter, caramel flavor and optionally further comprises fat and/or salt. In one embodiment, the kernel popcorn component essentially comprises about two-thirds of the charge; in other embodiments it can range from 30% to 90% of the charge. The food charge includes about 20% ground isomalt; in other embodiments the isomalt portion of the charge may range from about 10% to about 60%. The isomalt has a particle size of less than 1 mm. In one embodiment, the slurry represents about 13% of the charge and in other embodiments the slurry may be as low as about 1% to as high as about 40%. In one embodiment, about 2% of the food charge is made up of added water.

Manufacturing methods for filling a microwave popcorn bag with popcorn kernels, ground isomalt and slurry comprises in one embodiment the steps of:
A. providing a microwave popcorn bag having a sealed bottom end, an open sealable top end defining an upper orifice and a transversely extending seal area in an open configuration and in a vertically aligned orientation;
B. filling the bag through the upper orifice defined by the open top end with a quantity of popcorn kernels;
C. filling the bag with a quantity of slurry;
D. filling the bag through the upper orifice defined by the open top end with a quantity of an isomalt ingredient in particulate form; and,
E. sealing the open top end of the popcorn bag after the bag has been filled with the quantity of popcorn kernels and the quantity of isomalt ingredient to provide a microwave popcorn article.

### BRIEF DESCRIPTION OF THE DRAWINGS

FIG. 1 is a perspective view of an unsealed partially folded microwave popcorn bag ready for filling.

FIG. 2 is a diagrammatic view of one method of filling a microwave popcorn bag.

### DETAILED DESCRIPTION

The discussion herein relates to consumer packaged food items for the microwave preparation of sweet popcorn characterized by sweet coating that is resistant to heat scorching and to their methods of preparation and use. Each of the product components as well as product use and attributes and methods of their preparation are described in detail below.

Throughout this document, percentages are by weight and temperatures in degrees Centigrade unless otherwise indicated. Each of the US patents and US patent applications referenced herein are herby incorporated by reference.

The improvement described herein relates to microwave popcorn articles with an isomalt ingredient to provide the finished popcorn with a sweet coating and to their methods of preparation. The present microwave popcorn articles essentially comprise a microwave popcorn container such as a bag and a food charge disposed within the bag, said food charge comprising a quantity of 1) kernel popcorn, 2) an isomalt ingredient and can further include water and a slurry with various fat and flavoring ingredients. Each of these article components as well as methods of filling, product use and attributes are described in detail below.

### Microwave Container

The present microwave popcorn articles essentially comprise a conventional microwave popcorn popping container. Useful microwave containers herein can include any container for microwave popcorn products presently known in the art or are developed in the future. Cardboard tubs have also been recently developed for microwave popcorn articles and can be used as the microwave container. Particularly useful herein for the microwave popping container are a wide variety of commercially available microwave bags for microwave popcorn.

For example, a suitable bag widely used commercially and preferred for use herein is described in U.S. Pat. No. 4,450,180 patent. A generally similar bag is described in U.S. Pat. No. 4,548,826 or in U.S. Pat. No. 4,973,810 Microwave method of popping popcorn and package therefor” issued Nov. 27, 1990 to Arne Brauner. Also useful are structures described in U.S. Pat. No. 4,735,513 and U.S. Pat. No. 4,878,765. Generally, the bag therein described comprises and is fabricated from a flexible sheet material having two collateral tubular sections. The sections are parallel longitudinally extending that communicate with each other at the center of the package.

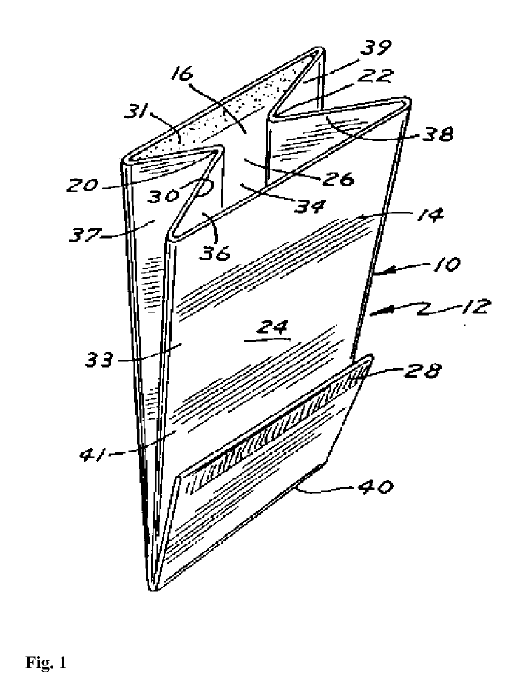

Referring now briefly initially to FIG. 1, there is shown an embodiment of a microwave popcorn article 10 composed of a microwave bag 12 formed from flexible sheet material such as paper and being of collateral tubular configuration, that is to say, being composed of a pair of parallel longitudinally extending tubes 14 and 16 which communicate with one another along a central longitudinal opening 18. The two parallel tubes 14 and 16 are separated by longitudinally extending side indentations 20 and 22. When the package comprises a paper bag, the bag can be composed of first and second face panels 24 and 26 respectively and the indentations 20 and 22 comprises gussets. When in a vertically aligned orientation, the bag has a bottom seal 28 and initially an open top or orifice 30 but a sealable seal area 31 that transversely extends the open sealable top. The sealable area can include a heat activated adhesive or a “cold seal” adhesive, as is convenient. After being filled, the top 30 is also sealed conventionally by means of heat or other suitable adhesive to provide a top seal in the top seal area 31.

The bag material is generally fabricated with multiple plies including an outer ply 33 which is generally paper, a grease-proof or resistant inner ply 34 and microwave susceptor film member or ply intermediate these inner and outer paper layers. However, in preferred embodiments the microwave susceptor is present only on one major face panel. The microwave susceptor provides supplemental heating for heating the food charge to cause popping of the popcorn.

While tubes (or chambers, or channels) 14 and 16 can be of equal size, conventionally the susceptor channel 16 is generally slightly smaller. In such a configuration, the gussets include major left gusset face 36, minor left gusset face 37, major right gusset face 38 and minor right gusset face 39. The bag 12 can be provided with a lower transverse fold 40 to define an intermediate portion or pocket 41.

Although in the present description, a particular description is given to this preferred microwave bag, the present improvement is also useful in connection with, for example, flat bottomed bags, bags with or without a bottom fold, with a straight bottom seal or other more complex bottom seal designs. Also, the present methods can be employed using new and improved microwave popcorn bag designs.

Since introduction, microwave popcorn bags have undergone continued development generally directed towards cost reduction especially of the expensive microwave susceptor component. Also, improvements continue to be made (see for example U.S. Ser. No. 09/943,637 “EASILY EXPANDABLE, NONTRAPPING, FLEXIBLE PAPER, MICROWAVE PACKAGE” filed Aug. 31, 2001 by Monforton) to improve popping performance or to facilitate commercial manufacturing at lower cost or at higher packaging line speeds.

While particular attention is given to microwave bags herein as the preferred microwave container, the skilled artisan will appreciate that the present article is broadly useful when used with a variety of packaging and disposable microwave containers.

### Popcorn

The present article 10 further includes a food charge disposed within the bag. The food charge essentially includes a quantity of kernel popcorn, the isomalt ingredient and can include fat(s), salt, and supplemental ingredients such as flavors, colors, vitamins and minerals, and/or supplemental sweeteners. The food charge can comprise from about 30 to 150 g in a microwave bag for example. For single serve products, the food charge can be smaller and can comprise about 30 to 100 g. For regular sized products, the food charge can comprise about 50 to 150 g, preferably about 100 to 130 g.

Conventionally, microwave popcorn food charge formulations are now expressed based upon the weight of the entire kernel popcorn and food charge. This convention is followed herein. Broadly, the popcorn can range from about 30 to 90% of the popcorn charge. Typically, about 15 to 100 g of kernel popcorn is added to the bag, preferably about 50 to 70 g/bag for regular sized products and about 25 to 40 g/bag for “single portion” sized products. In general practice, the amount of kernel popcorn is set and the other ingredients are varied to provide variations such as full fat, reduced or low fat, and/or salted or low salt embodiments.

Generally, microwave popcorn is dried to moisture contents ranging from about 10% to 18%, preferably about 12% to 16% and for best results about 14% to insure sufficient moisture for popping of a high fraction of kernels while minimizing moisture that might cause or promote bacterial growth during the long term distribution and storage characteristic of shelf stable packaged products.

Conventional kernel popcorn varieties can be used and are preferred for use herein. Also useful herein are relatively larger kernel popcorn varieties for providing “Jumbo Pop” products as well as “mushroom” sized popcorn which is commonly used for ready-to-eat popcorn snack products. Useful are those larger varieties having a kernel count up to 60 kernels per 10 g, preferably less than 55, which are commercially available.

In certain variations, the popcorn can be infused with materials, e.g., flavor or colors, intended to provide popcorn products of enhanced visual or flavor appeal. In other variations, the popcorn can be bred to provide natural color and/or flavor variations.

Additionally, all or a portion of the microwave popcorn can be substituted with expandable or microwave puffable pellets such as are descried in the '250 patent to Van Hulle. Also useful herein are those products described in U.S. Pat. No. 5,102,679 “Half products for microwave puffing of expanded food product” issued Apr. 7, 1992 to Whelan. See also U.S. Pat. No. 6,083,552 “Microwaveable Popcorn Product And Method” issued Jul. 4, 2000 to Kershman et al. In certain variations comprising a blend of kernel popcorn and puffable pellets, weight ratio of the kernel popcorn to puffable pellets can range from about 10:1 to about 1:10, preferably about 1:4 to about 4:1 and for best results about 1:3 to about 3:1.

### Glaze Forming Carbohydrate

The microwave food charge additionally comprises a moderate sweetness carbohydrate glaze forming ingredient. Useful here as the glaze forming ingredients are those browning resistant moderate sweetness carbohydrates of thermal stability such that they that melt or at least soften to form a parisol flowable under gravity (i.e., are at least thermoplastic) at temperatures below 170° C. but also a have smoke point values higher than about 125° C. and thus exhibit heat stability during brief exposure to the high microwave popcorn popping which generally occurs at a temperature of about 170-180° C. By moderate sweetness is meant having a sweetening power of about 0.1 to 2 relative to sucrose.

Useful glaze forming carbohydrates can be selected from the group consisting of isomalt, maltitol and lactitol and mixtures thereof. Preferred for use herein due to availability, cost and reduced laxative properties is isomalt.

The isomalt ingredient upon microwave heating provides a sweet coating to the puffed popcorn. Isomalts are well known and the skilled artisan will have no difficulty in selecting useful commercially available isomalt ingredients from commercial suppliers. Discovered in the 1960s, ISOMALT has been used in Europe since the early 1980s and is currently used in a wide variety of products in more than 50 countries worldwide. ISOMALT is made from sucrose and can be supplied in the form of bead particulates. It is white, crystalline and odorless. ISOMALT is a mixture of two disaccharide alcohols—gluco-mannitol and gluco-sorbitol. Sucrose, by comparison, is a disaccharide sugar, gluco-fructose. Chemically, isomalt belongs to the class of disaccharide polyols like maltitol and lactitol. It is derived exclusively from sucrose. It consists of two components in a 1:1 ratio, 1,6-glucopyranosyl-D-sorbitol (GPS) and 1,1-glucopyranosyl-D-mannitol (GPM). Compared to the group of polyols currently used as sweeteners, isomalt like maltitol and lactitol has a high molecular weight of 344.

Isomalt is a bulk sweetener exhibiting a very clean sucrose-like taste profile with no significant off-tastes or aftertastes. Isomalt liquid grade contains a blend of pure crystalline isomalt and maltitol syrup sometimes fortified with minor amounts of hydrogenated oligosaccharides. Isomalt has a sweetness potency 50% that of sucrose. Consequently, when using pure crystalline isomalt a combination with an intense sweetener may be required.

Isomalt is made from sugar; is used in a variety of foods and pharmaceuticals; provides the taste and texture of sugar; is synergistic with other sweeteners; is low calorie (provides at most 2 calories per gram); does not promote dental caries; and does not increase blood glucose or insulin levels

While liquid isomalt can be used, preferred for use herein is isomalt in particulate form. In particulate form, especially when used in combination with a hydrogenated fat component, the isomalt ingredient is adhered to and intermixed with the popcorn and is thus less likely to migrate within the microwave popcorn bag during distribution and storage prior to use. While particulate isomalt is available in the form of larger sized particles, it has been found useful herein to employ isomalt in particulate form having an average particle size of less than 1 mm. Larger particles can exhibit only partial or incomplete melting upon microwave cooking to provide popped popcorn with an incomplete coating or a coating having a mottled appearance. Isomalt can be simply and conveniently milled or ground into a powder prior to addition to the microwave container. While the isomalt can be ground to a fine powder, e.g. having an average particle size ranging up to 500 microns, in preferred form, the isomalt or other glaze forming carbohydrate is ground to a coarse powder having an average particle size ranging from about 2500-800 microns, preferably in one embodiment, and ni another embodiment from about 250-600 microns. Within this preferred range, finished coated popcorn having a mottled appearance is minimized while dust control in production is also likewise minimized.

Maltitol is a member of a family of bulk sweeteners known as polyols or sugar alcohols. It has a pleasant sweet taste—remarkably similar to sucrose. Maltitol is about 90% as sweet as sugar, non-carcinogenic, and significantly reduced in calories. Maltitol is especially useful in the production of sweets, including sugarless hard candies, chewing gum, chocolates, baked goods and ice cream. It is available worldwide from Cerestar, Roquette, SPI Polyols, Inc. and Towa Chemical Industry Co., LTD.

Maltitol is made by the hydrogenation of maltose which is obtained from starch. Like other polyols, it does not brown or caramelize as do sugars. Maltitol's high sweetness allows it to be used without other sweeteners. It exhibits a negligible cooling effect in the mouth compared to most other polyols. Although maltitol is often used to replace sugars in the manufacture of sugar-free foods, it may also be used to replace fat as it gives a creamy texture to food.

Lactitol is manufactured by reducing the glucose part of the disaccharide lactose. Unlike the metabolism of lactose, lactitol is not hydrolyzed by lactase. It is neither hydrolyzed nor absorbed in the small intestine. Lactitol is metabolized by bacteria in the large intestine, where it is converted into biomass, organic acids, carbon dioxide and a small amount of hydrogen. The organic acids are further metabolized resulting in a caloric contribution of 2 calories per gram (carbohydrates generally have about 4 calories per gram).

The food charge for a traditional glaze product can comprise about 20% to about 50% of the glaze forming carbohydrate ingredient(s). Preferably the isomalt is present in the food charge in the microwave popping article at ranges from about 35 to 45% and for best results about 38 to 42%. For a light glaze product there is less isomalt present. In one embodiment of a light glaze, there is about 15 to 25% isomalt in the food charge. In a preferred embodiment of a light glaze, there is about 20% isomalt in the food charge.

The present thermally resistant glaze forming ingredient(s) is to be distinguished from those carbohydrates or sugars that either scorch during microwave heating or that do not melt or soften under microwave heating.

### Fat

The food charge of the present articles can additionally comprise a quantity of an edible fat. Generally, the present methods are useful in connection with full fat, reduced-fat and with low-fat embodiments or even no-fat embodiments, and are particular suitability for use in connection with snack products that are perceived as being more healthy, such as low fat microwave products. Also useful herein are reduced fat or full fat products. Low fat products have an even lower fat content than reduced fat embodiments. Reduced fat products have a fat content of about 8 to 15% fat. All fat percentages are descriptive of added fat and are not meant to include fat which may be included in the finished product from other ingredients, e.g., the fat from the kernel popcorn. Thus, broadly, the fat can range from about 0 to 40% and about 1 to 25% in reduced fat embodiments. In some reduced fat embodiments, the fat ranges from 8 to 17%, 10 to 15% or preferably 11 to 12%. Full fat products can comprise about 20 to 35% fat. In the low fat embodiments the charge essentially comprises about 2 to 10% fat, preferably 5 to 8% fat and for best results about 6.5%.

The fat, preferably semi-solid or solid fat, can be from any conventional, suitable fat(s) or oil(s) or mixtures thereof from vegetable or animal sources including from soybean, cottonseed, safflower, corn, peanut oil(s), butter oil and mixtures thereof. Liquid oils (medium chain triglycerides or interesterified oils) can be used in full or in part as a possible variation to reduce trans fatty acid oils. Liquid oils can be thickened to increase their viscosity (e.g., with silicon dioxide or by being fortified with small amounts of fat hardstock). In other variations, the oils can be partially hydrogenated. Suitable for use herein are fats that are partially hydrogenated soybean and/or corn oil. Also useful herein are tropical oils such as coconut oil and palm kernel oil, although present consumer health trends disfavor utilization of such oils. Also useful herein are non-absorbable fat mimics such as polyglycerol esters. In one variation, the fat ingredient is selected to provide microwave popcorn products having a low level of trans fatty acids. (See for example, U.S. Pat. No. 6,013,291 “Microwave Popcorn with Liquid Fat and method of Preparation issued Jan. 11, 2000 to Glass et al.), i.e., having no more than 30% of the fat comprising trans fatty acids, more preferably less than 5% of the fat and for best results less than 2%.

In one variation, at least a portion of the fat is supplied by a low moisture butter ingredient. Suitable low moisture butter ingredients and methods of preparing microwave popcorn products therewith are described in commonly assigned U.S. Pat. No. 5,919,505 and/or U.S. Pat. No. 6,093,429 “Shelf-Stable Butter Containing Microwave Popcorn” issued Jul. 25, 2000 or U.S. Pat. No. 6,333,059. In general, however, the butter ingredients therein described are low moisture (i.e., less than 3%) butters that are commercially available. The fat/butter blends comprise about 750 ppm antioxidants. To assure shelf stability, the butter content is preferably limited to 10% of the added fat.

### Salt

The present microwave popcorn articles can additionally include a salt component. While microwave popcorn products without added salt are contemplated herein, in preferred embodiments, the food charge for a traditional glaze product additionally includes about 0.1% to about 5% added salt, preferably about 0.5% to about 4% salt and for best results about 0.5% to about 2.5% salt. For a light glaze there is less salt present. Because there is less isomalt in a light glaze product, there is less salt to maintain the flavor balance. In one embodiment of a light glaze, there is 0.05 to 1% salt in the food charge. In a preferred embodiment of a light glaze, there is about 0.3% salt in the food charge. Typically, the salt component is a microsized salt, also known as ultrafine salt or pulverized salt or “flour” salt, typically having a mean particle size of about 22 microns. This flour salt is simply physically admixed in with the melted fat component to form a fat and salt slurry.

In some embodiments, at least a portion of the total salt can be added in the form of a flour sized particulate to the slurry. In those embodiments, it is more preferred that the portion of the total salt added as a salt flour to the slurry be at least 60% of the total salt, even preferably more than 75% of the total salt.

In certain variations, a coarse salt ingredient can be employed such as described in commonly assigned U.S. Pat. No. 5,897,894 “Microwave Popcorn With Coarse Salt Crystals and Method of Preparation” issued Apr. 27, 1999. Generally, the coarse salt therein described has a larger particle size of about 250 to 600 μm. Such coarse salt is added to impart an organoleptic attribute in the finished product microwave popcorn to be more reminiscent of the stove-top at-home popped and seasoned popcorn. While in some preferred embodiments herein the salt is in flour form, in other embodiments all or a part of the salt can be in the form of coarse salt added in the third or even a fourth station or in the separate particulates addition step herein.

While common sodium chloride is the preferred salt, also useful in full or partial substitution is potassium chloride. While employments of potassium chloride in full or partial substitution finds appeal to those consumer interested in limiting their sodium chloride intake, some consumers find potassium chloride bitter in taste. 50:50 weight blends of potassium and sodium chloride salts are common. While not common, any of the salts can be iodized to provide essential iodine fortification.

### Calcium Ingredient

The present microwave popcorn products can optionally further comprise a calcium ingredient of defined particle size in an amount effective to provide the desired calcium enrichment. (See, for example, U.S. Pat. No. 5,997,916 “Microwave Popcorn Fortified with Calcium and method of Preparation issued Dec. 7, 1999 to Dickerson et al.). Good results are obtained when the present microwave popcorn products contain about 360 to 3600 mg of calcium per 100 grams of the food charge. Better results are obtained when the calcium is present at levels of about 360 to 1800 mg per 100 grams. For best results, the total calcium present ranges from about 930 to 1400 mg per 100 grams of the food charge. Excessive calcium fortification is to be avoided in part because the finished product can undesirably exhibit a dry texture, gritty mouth feel, and lower taste perception of flavor and salt.

The calcium mineral is essentially characterized by a particle size wherein at least 50% of the calcium component has a particle size of about 1 to 20 microns (“μm”).

At a calcium concentration of 360 to 930 mg per 100 grams of the food charge, the finished popped product provides about 10% of the currently recommended daily intake for calcium and thus can be described as “a good source of calcium.” The levels in the microwave article suitable for microwave popping account for an estimated 40% loss factor for calcium as the popcorn goes from its unpopped state to the popped state. In addition, these levels also reflect the amount consumed based on the current serving size of 30 grams for popped product as defined by the Food and Drug Administration (FDA).

Useful herein are calcium ingredients that supply at least 20% calcium. For example, a good calcium ingredient herein is calcium carbonate in that calcium carbonate comprises about 40% calcium.

Preferred for use herein are calcium ingredients selected from the group consisting of food grade calcium carbonate, ground limestone, calcium phosphate salts and mixtures thereof.

### Optional Minor Ingredients

The present food charges can comprise a variety of ingredients to improve the taste, appearance and/or nutritional properties of the finished sweet coated popped popcorn herein.

### Supplemental Sweeteners

In particular, the food charges can comprise an effective amount of a heat tolerant high potency sweetener such as potassium acesulfame, sucralose or mixtures thereof. Sucralose is preferred for use herein since acesulfame K (colloquially, “Ace K”) can impart a bitter taste to some consumers sensitive to potassium. Alitame, neotame, saccharin and cyclamates can also be employed subject to current food regulations relating to microwave popcorn products. Thaumatin can also be used and provides the advantage of flavor masking off flavors. Also useful herein are trehelose, taglatose and mixtures thereof. In less preferred variations, the products can employ supplemental high potency “natural” or plant sweeteners such stevioside such as from ground stevia leaf, stevia extract (an herb, Stevia rebaudian, native to Peru and Paraguay) or essence or tincture of Rubus suavissimus. Such products are used at amounts effective to provide desired sweetness levels. Such materials are often blended with or formed into powder form by mixing with a solid substrate or carrier such as a starch or maltodextrin. While not temperature stable per se, the sweeteners can be added at levels that compensate for losses during microwave heating. Generally, such products are used at levels ranging from about 0.05% to about 1% depending upon sweetening power of the active ingredient and concentration of the active ingredient in the sweetener ingredient. Preferred for use are sucralose, acesulfame, and mixtures thereof since such sweeteners are more resistant to scorching than the plant derived sweeteners.

While in the preferred embodiment the particulate addition in the third or separate particulate addition step after the slurry has been added is a calcium ingredient, the skilled artisan will appreciate that other particulates can be conveniently added in the third filling station or in this step. Such additional particulates can include a wide variety of materials intended to provide various flavor or nutritional advantages. Such materials include sugars, dried dairy ingredients such as dried cheese solids, other minerals, flavored bits, colorants, and mixtures thereof.

In some embodiments, the present microwave products are additionally characterized as being sugar free (i.e., by total mono- or disaccharide content of less than 0.5%). Such products exhibit greater shelf stability as well as minimization of sugar related scorching and burning. However, the products can include minor amounts of flavor ingredients that are intended to provide an enhanced caramel flavor or color such as caramel flavors or colors.

In other more preferred embodiments, the present microwave products are additionally characterized as being free of a cheese constituent (i.e., having a cheese ingredient content of less than 0.5%, dry weight basis). Cheese ingredients can also undesirably contribute to scorching and burning problems in microwave popcorn products. It is believed that these problems are due to the protein and their carbohydrate (e.g., lactose) constituents thereof. Thus, dried cheeses being generally low in fat and thus high in other constituents are particularly undesirable. Generally, the food charges should minimize the presence of those ingredients that cause undesirable browning or burning at the high temperatures 160-170° C. characteristic of microwave popcorn popping.

In preferred variations, the food charge is substantially free (i.e., less than 0.5%) of any mono or disaccharides or sugars such as sucrose. lactose, fructose, corn syrup, dextrose, corn syrup solids, dried honey, fruit juice solids, fruit paste or proteins that would brown or burn during microwave popping. In highly preferred embodiments, the present articles are both sugar(s) free and cheese ingredient free.

In preferred variations, the food charge also includes about 0.05 to 1% caramel flavor.

One formula that yields a particularly good combination of characteristics, including non-scorching, reduced heating of product and bag, as well as flavor characteristics, is a food charge of:

| Ingredient | Weight (g) |
|---|---|
| 20-5001 Corn | 59.00 |
| 00-0000 Slurry | 11.35 |
| 22-8415 Isomalt | 17.45 |
| (Ground) | |
| 00-0000 H20 | 2.00 |
| Total | 89.80 |

The slurry for the food charge above is:

| | % of Slurry by |
|---|---|
| Ingredient | Weight |
| 22-3877 Shortening | 89.500% |
| #14 | |
| 20-3870 Salt | 2.169% |
| 20-2313 Butter High | 2.194% |
| Fat | |
| 20-3360 Lecithin | 0.289% |
| 20-4240 Sucralose | 0.698% |
| 22-8642 Caramel | 2.194% |
| Flavor | |
| 20-2153 Butter #90 | 0.415% |
| 20-1581 Butter #91 | 0.218% |
| 22-8364 Brown Color | 1.994% |
| #44 | |
| 91-0443 Talin | 0.329% |

The composition of the overall food charge including slurry ingredients is:

| | % of Food Charge |
|---|---|
| Ingredient | by Weight |
| Corn | 65.70% |
| Isomalt | 19.43% |
| Water | 2.23% |
| Shortening #14 | 11.312% |
| Salt | 0.274% |
| Butter High Fat | 0.277% |
| Lecithin | 0.037% |
| Sucralose | 0.088% |
| Caramel Flavor | 0.277% |
| Butter #90 | 0.052% |
| Butter #91 | 0.028% |
| Brown Color #44 | 0.252% |
| Talin | 0.042% |

Thus in the above example, the total added fat in the food charge is about 11.7%.

### Method of Preparation

Broadly, the present methods of preparation include the steps of adding the food charge to an at least partially open microwave popping container to form a filled container and sealing the filled container to provide a finished sweet coating microwave popcorn article product.

In one variation, the food charge is formed in a single composite mass such as a toroid or ring and the composite mass charged to an open microwave popcorn bag or other container prior to final sealing. (See for example U.S. Pat. No. 4,450,180, issued May 22, 1984).

In another variation one or more ingredients are added separately to the open microwave bag. For example, microwave bags having an unsealed open end and a folded lower portion are advanced to a first kernel popcorn filling station. While being maintained in an open position, the loose kernel popcorn is charged to the desired channel in desired amounts to form partially filled bags containing kernel popcorn. The kernel popcorn is added first to facilitate more even distribution of the balance of ingredients over the popcorn to thereby provide a finished popcorn having a more even distribution of the coating ingredients. In those variation that include puffable pellets other than or in admixture with kernel popcorn, the puffable pellets or popcorn-and-pellet mixtures are likewise first added to the microwave popcorn bag.

Thereafter, the partially filled bags are advanced to a second filling station at which a slurry is added to the bag. Typically, the slurry is added in the form of a vertically dispensed pencil jet (i.e., a confined stream) of the slurry. (See, for example, U.S. Pat. No. 4,604,854 entitled “Machine For Forming, Filling and Sealing Bags,” issued Aug. 12, 1986 to D. W. Andreas). The slurry contains the fat ingredient(s), is typically heated to melt a solid fat to liquid or fluid form, and optionally includes flavors, colors, etc. For those embodiments comprising salt in flour form, the slurry can include all or a portion of the flour salt. At the same station, a separate quantity of the isomalt or other glaze forming carbohydrate is added to the open partially filled microwave popcorn bag (See, for example, FIG. 1 line 70). The slurry addition and isomalt addition can be practiced sequentially (in either order) or simultaneously. Simultaneous addition or parallel addition is preferred since this technique allows for high packaging line processing speeds thereby increasing efficiency compared to sequential addition in a two station filling method. In preferred form, the isomalt is added in the form of a powder. Other particulate or dry ingredients, e.g., salt in coarse form and/or calcium, flavors, colors, can conveniently be admixed with the isomalt.

Single station filling methods are also known that involve applying the fat/salt slurry as a spray onto the kernel popcorn as the kernel popcorn falls into the bag. (See, for example WO 95/01105 entitled “Reduced Fat Microwave Popcorn and Method of Preparation” published Jan. 12, 1995, or, equivalently, U.S. Pat. No. 5,690,979 issued Nov. 25, 1997; or U.S. Pat. no. 5,171,950 “Flexible Pouch and Paper Bag Combination For Use In The Microwave Popping of Popcorn” issued Dec. 5, 1992 to Brauner et al.) which is incorporated herein by reference. Such single station filling techniques are especially useful for the preparation of low fat microwave popcorn products. In this variation, the isomalt in powder form can be added to the popcorn filling funnel along with the popcorn, e.g., after the popcorn has been charged to the bag.

The bags now containing both kernel popcorn and slurry and other ingredients are then advanced to a sealing station where the bags are provided with a top seal to complete the closure of the bag. The sealed popcorn bags are advanced to subsequent finish packaging operations that complete the folding of the bags, providing the bags with an overwrap, and inserting appropriate numbers of the bags into cartons, etc.

While single station and two station filling methods can be used to prepare the present sweet coating microwave popcorn products herein, it has been surprisingly discovered that three station filling embodiments that are convenient and useful for fabricating the present sweet coating microwave popcorn article products (See for example U.S. Pat. No. 5,997,916 “Microwave Popcorn Fortified With Calcium And Method of Preparation” issued Dec. 17, 1999) or addition of coarse salt (See for example U.S. Pat. No. 5,897,894 “Microwave Popcorn With Coarse Salt Crystals and Method of Preparation” issued Apr. 27, 1999 to Brian Glass or U.S. Pat. No. 6,210,721 “Microwave Popcorn Incorporating Coarse Salt and Method of Preparation” issued Apr. 3, 2001 to Dickerson et al.).

Adding the isomalt along with the salt to the slurry can result in a first problem of increased slurry viscosity. The slurry viscosity rises rapidly as more particulates are added. If an additional particulate is desired to be added to the slurry such as for the sweetener coating, then addition of requisite amounts of salt to the slurry results in a slurry having a paste consistency and a viscosity too high to pump. This is especially true in the more concentrated slurry typically used for ultra low fat popcorn—usually about 94% fat free. Additionally, high levels of particulate contents in the slurry can result in some settling in turn leading to loss of homogeneity in the slurry added to the bag.

A second problem is plugging of the orifice of the pencil jet nozzle used to charge the slurry to the bag that can occur when the slurry viscosity is too high. While plugging is a problem when salt alone is added to the slurry, such plugging problems are compounded when the slurry contains supplemental particulates such as the isomalt ingredient.

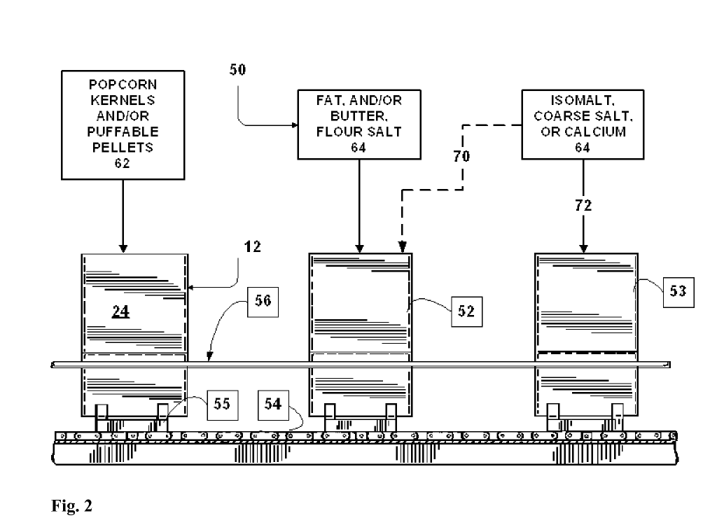

Now referring to FIG. 2, there is seen a schematic of a preferred method of preparation preferred for use herein generally designated by reference numeral 50. The drawing shows a conventional microwave packaging line and depicts three stations thereof designated generally by reference numbers 51, 52 and 53. In upstream stations, (not shown) the tubular bag material is cut into desired lengths, and is provided with the bottom seal 28 or purchased pie cut and bottom sealed. Additionally, in upstream stations (not depicted), the bags 12 are folded to have their bottom third folded up as depicted in first station 51 of FIG. 2 to provide the first lower transverse fold 40 to provide a sealed portion so that the kernel popcorn, fat charge, and isomalt can be positioned within the bag in the desired middle portion 41 thereof. The bags 12 are advanced from station to station (left to right) by suitable drive means such as the endless drive chain 54 depicted having bag engagement clips 55. Packaging line speeds range from about 40 to over 100 bags per minute. Also, the bottom third of the bags are maintained in the closed position by appropriately spaced parallel guide bars 56 and 58. As can be seen, the bag has an open sealable top portion defining an orifice and has a seal area extending across the orifice. The bag at station 51 is provided in an open configuration and in a vertically aligned orientation.

In the present preferred method of filling microwave popcorn bags, the first station 51 is a popcorn filling station. As indicated above, the fat is heated to form a liquid fat. The fat addition is charged to the bag at a second separate station 52. Optionally, admixed with the fat are any butter ingredients and/or fat soluble flavors, e.g., butter and any portion of the salt that is in flour salt sized form to form the fat slurry.

Thereafter, the bags still being maintained in the upright, folded orientation depicted in FIG. 2 are advanced in the preferred embodiment to the third particulate filling station 53. At the particulate filling station, a quantity of a isomalt in particulate form is then charged to the bag 12 in a separate step as indicated by addition line 72 to form an open ended microwave popcorn bag filled with the food charge.

Once filled with the popcorn, fat slurry and particulate, the bags are then advanced to the sealing station (not shown) wherein the open top end is sealed such as by retractable heat or pressure sealing jaws which impart a seal in the seal area to form finished sealed microwave popcorn articles for the microwave preparation of a sweet microwave popcorn.

The filled and sealed microwave popcorn bags can then be advanced to subsequent downstream packaging operations (not shown). Such subsequent downstream packaging operations can and preferably include folding the bags again to provide a three-folded bag, i.e., to provide a second upper transverse fold; overwrapping the folded bags with an overwrap or moisture barrier layer; and inserting desired numbers (e.g, 1 or 3-6 to, preferably 5-6, of the packaged article into cartons or even 10 to 40 especially for variety packs).

Now that the present methods have been described in general terms, in particular, at the filling station 51 the process involves the step 62 of filling the bag through the upper orifice with a quantity of popcorn kernels. Generally, however, the process step can conveniently be practiced at filling station 51 by employing a means for dispensing a measured quantity of kernel popcorn such as a dispensing wheel. The dispensing wheel discharges at timed intervals a measured quantity (e.g., 50 to 70 g) of the kernel popcorn into a vertically oriented filling horn or funnel. The funnel causes the kernel popcorn to fall by gravity into the bag 12.

At the second or fat slurry filling station 52, the present methods additionally include the step 64 of filling the bag 12 through the upper orifice with a quantity of fat (with or without butter).

The term slurry is used herein as is common in the microwave popcorn art to refer to any coating applied to the kernel popcorn. The term “slurry” as used generally herein thus includes fat alone; fat and a lesser portion of salt in flour form; fat, flour salt, flavors and/or color or sweetener(s); fat, a portion of the flour salt and a portion of the calcium ingredient; and fat and substantially all of the calcium ingredient as well as any other variation or combination of ingredients used as an addition to the kernel popcorn herein.

The slurry can additionally optionally comprise minor amounts of other materials employed to make the microwave popcorn more aesthetically or nutritionally or organoleptically appealing. Such adjuvant ingredients can include, for example, limited amounts of sugar(s), micro fortification levels of minerals, vitamins, colorants, preservatives and flavors. If present, each of these constituents can comprise from about 0.01 to about 2% by weight of the fat slurry.

Especially popular for use herein is a butter flavor. The flavors can be either in liquid, fat soluble forms and/or in dry powder forms such as a liquid oil absorbed onto a particulate carrier, e.g., gum arabic, starch, silicon dioxide, or dehydrated cheese solids or in the form of an oil suspension.

The fat slurry is prepared simply by admixing the fat (in a fluid or melted state) together with any optional ingredients with salt and blending the mixture to form a stable dispersion or slurry. The fat or slurry, while still fluid (70° to 130° F.; 21° to 55° C.), is then sprayed into the microwave popcorn bag as described in detail below.

The slurry application step can be practiced by employing an applicator for spraying the fat slurry (e.g., commercially available from Hibar Systems Limited, Ontario, Canada) that is supplied by a slurry supply means (not shown). The slurry supply means can conveniently include a conventional positive displacement reciprocating metering pump having a piston and a pressurized slurry inlet. The pump precisely pumps metered amounts of the fat slurry to the applicator at closely controllable time intervals.

If the slurry viscosity is too high, the slurry becomes unpumpable. The concentrations of salt and calcium ingredients are selected such that the slurry has a viscosity of less than 10,000 cps, preferably less than about 1,000 cps, and, for best results, less than 300 cps.

The slurry can be added at temperatures ranging from about 15.5° to 65.5° C. (60° to 150° F.), preferably about 38° to 54.4° C. (100° to 130° F.).

While a pencil jet spray is preferred for use herein, equivalents thereof in terms of dispensing the slurry can also be used. For example, a multiplicity of very fine jet streams, (e.g., 3-12), or a sparge can be used to achieve the desired dispersion hereunder. Also, other spray types, (e.g., a cone spray, a mist spray, or a fan spray) are useful herein. However, great care must be taken in selecting such useful alternatives so as to avoid getting slurry in the bag seal area. In other embodiments, the spray can be gas assisted, e.g., air, steam, or inert gas.

In preferred embodiments, the bag 12 has a microwave chamber (i.e., wherein one major face panel has an intermediate microwave susceptor layer between the inner and outer bag layers) and, for cost considerations, a microwave susceptor-free chamber. In the preferred practice, the kernel popcorn, fat slurry and particulate(s) are charged to the microwave channel. Conventionally, the microwave channel is the lesser channel (i.e., being formed by the smaller major face 24) and the greater channel is the microwave free channel. Such a configuration minimizes the amount of relatively expensive microwave susceptor material required while nonetheless providing the needed expansion volume upon microwave popping.

In the preferred form, the popcorn charging and slurry addition are practiced at separate stations and as separate steps. However, in other embodiments, the kernel popcorn and slurry addition can be practiced in a single station concurrently. Apparatus and techniques for such concurrent filling of the popcorn and slurry are described in commonly assigned U.S. Pat. No. 5,690,979 (issued Nov. 25, 1997) entitled “Method Of Preparing Reduced Fat Microwave Popcorn.”

At station 53, it can be seen that the present methods additionally comprise the step 66 of filling the bag with a quantity of a particulate after the bag is filled with popcorn and fat. Generally, however, the particulate filling station 53 includes a means for dispensing a measured quantity of particulates such as the isomalt, salt, calcium ingredient(s), other particulates and mixtures thereof.

If high levels of salt and calcium ingredients are desired in the finished products, addition of the total quantity of each of these materials to the slurry will cause the slurry viscosity to be excessively high. That is, while the slurry may be able to carry all of the salt or all of the calcium ingredient, or half of each, the slurry cannot carry all of both. Thus, either all of the salt or all of the calcium ingredient or a portion of each (e.g., 50:50 or 70:30) must be added as dry particulates in the third filling station or in the present essential particulates addition step. Useful herein for practicing this step are particulate metered feeding equipment that are commercially available such as are used for filling salt or sugar packets.

The present methods further essentially include a conventional finish step (not shown in FIG. 2) of sealing the open end of the microwave popcorn bag after the bag has been filled with the quantity of popcorn kernels, the fat slurry and the quantity of particulates.

### Product Use

The microwave popcorn products prepared as described can be used in a conventional manner for the at-home preparation of a sweet coated popcorn by microwave heating. Upon microwave heating of the sealed microwave popcorn article in a conventional home microwave oven, the resultant popped popcorn in the form of free flowing of individual substantially unagglomerated popped popcorn kernels exhibits excellent organoleptic attributes notwithstanding the sweet coating and with minimal scorching or browning.

What is claimed is:

1. A microwave popcorn article comprising a microwave popcorn bag, and a food charge disposed therein comprising:
about 30-90% unpopped popcorn kernels;
about 8-17% fat; and
about 15-25% glaze-forming carbohydrate.

2. The microwave popcorn article of claim 1 wherein the food charge comprises about 20% glaze-forming carbohydrate.

3. The microwave popcorn article of claim 1 wherein the glaze-forming carbohydrate forms a parasol flowable under gravity below 170° C.

4. The microwave popcorn article of claim 1 wherein the glaze-forming carbohydrate has a smoke point value greater than about 125° C.

5. The microwave popcorn article of claim 1 wherein the glaze-forming carbohydrate is isomalt, maltitol or lactitol.

6. The microwave popcorn article of claim 5 where in the glaze-forming carbohydrate is isomalt.

7. The microwave popcorn article of claim 1 claims wherein the food charge comprises about 10-15% fat.

8. The microwave popcorn article of claim 7 wherein the food charge comprises about 11-12% fat.

9. The microwave popcorn article of claim 1 wherein the fat comprises a low-moisture butter.

10. The microwave popcorn article of claim 1 wherein the food charge further comprises a caramel flavor.

11. The microwave popcorn article of claim 10 wherein the caramel flavor is about 0.05-1% of the food charge.

12. The microwave popcorn article of claim 1 wherein the food charge further comprises sucralose.

13. The microwave popcorn article of claim 12 wherein the sucralose is about 0.05-1% of the food charge.

14. The microwave popcorn article of claim 1 wherein the food charge further comprises salt.

15. The microwave popcorn article of claim 14 wherein the salt is about 0.05-1% of the food charge.

16. The microwave popcorn article of claim 14 wherein more than 75% of the salt is a flour-sized particulate.

17. The microwave popcorn article of claim 1 which is substantially free of mono- and disaccharide sugar.

18. The microwave popcorn article of claim 1 wherein the food charge further comprises about 2% water.
